(19) United States
(12) Patent Application Publication
(10) Pub. No.: US 2024/0230040 A1
(43) Pub. Date: Jul. 11, 2024

(54) HIGH-VOLTAGE RUBBER WIRE LIGHT

(71) Applicant: Jianmin SHAO, Taizhou (CN)

(72) Inventor: Jianmin SHAO, Taizhou (CN)

(21) Appl. No.: 18/150,544

(22) Filed: Jan. 5, 2023

(51) Int. Cl. F21S 4/26; F21V 19/00; F21V 23/00; F21V 23/02

(52) U.S. Cl. CPC F21S 4/26; F21V 19/002; F21V 23/002; F21V 23/02; F21Y 2115/10

(57) ABSTRACT

The present invention discloses a rubber wire light. Power wires are embedded in the power plug and provided with parallel light-emitting diode (LED) light sets. Each of the LED light sets includes a plurality of light-emitting diodes connected in series, a resistor, and a bridge rectifier. The power wires include a positive wire and a negative wire. Each of the LED light sets has one end connected to the positive wire and the other end connected to the negative wire. The light-emitting diodes, the resistor, the bridge rectifier, and the power wires are connected via electrical wires. Rubber wire sheaths are arranged outside the electrical wires. The resistor is arranged at one end close to the positive wire. The bridge rectifier is arranged at one end close to the negative wire. The light-emitting diodes are arranged between the resistor and the bridge rectifier.

### TECHNICAL FIELD

The present invention relates to the technical field of colored lights, and more specifically, to a high-voltage rubber wire light.

### BACKGROUND

Light-emitting diodes (LEDs) can only be turned on in one direction and have nonlinear volt-ampere characteristics, and therefore cannot be directly powered by using a 220 V alternating current of mains electricity and needs to be powered by using a stable direct current obtained by converting the mains electricity through a power supply. At present, most of strip lights and bridge rectifiers for rectification on the market are arranged on a circuit board, and then the circuit board is placed in a housing for lighting. In this way, the shape of the strip lights has been fixed and cannot be changed, so that decorative lighting cannot be achieved; and this mounting method is more time-consuming, which affects the efficiency of mass production. Therefore, to avoid the shortcomings existing in the prior art, it is necessary to improve the existing strip lights.

### SUMMARY

In view of the deficiencies existing in the prior art, an objective of the present invention is to provide a high-voltage rubber wire light.

To achieve the above objective, the present invention provides the following technical solution: a high-voltage rubber wire light, including a power plug, where power wires are embedded in the power plug and provided with parallel light-emitting diode (LED) light sets, and each of the LED light sets includes a plurality of light-emitting diodes connected in series, a resistor, and a bridge rectifier.

Further, the power wires include a positive wire and a negative wire, and a voltage between the power wires is set to be 110 V.

Further, each of the LED light sets has one end connected to the positive wire and the other end connected to the negative wire, the light-emitting diodes, the resistor, the bridge rectifier, and the power wires are connected via electrical wires, and rubber wire sheaths are arranged outside the electrical wires.

Further, the resistor is arranged at one end close to the positive wire, the bridge rectifier is arranged at one end close to the negative wire, and the light-emitting diodes are arranged between the resistor and the bridge rectifier.

Further, pins of the bridge rectifier are connected to the light-emitting diodes and the negative wire, respectively, and the joints are sheathed with insulating protective sheaths.

Further, the LED light sets are evenly and equidistantly arranged between the power wires.

With the adoption of the above technical solution, the present invention has the following beneficial effects: 1. The bridge rectifier is directly connected to the light-emitting diodes, which saves the steps of a production process; and the insulating protective sheaths for sheathing the joints may ensure that electrical leakage or breakage does not occur at the joints, and the service life of the rubber wire light may be prolonged; 2. Through the arrangement of the bridge rectifier, an alternating current may be rectified and converted into a direct current available for the light-emitting diodes, which improves the stability of the rubber wire light; and 3. The resistor is configured to stabilize a voltage of a circuit, which may ensure the working stability of the rubber wire light; and the resistor is simple in structure, easy to connect, and convenient for use in the high-voltage rubber wire light.

### BRIEF DESCRIPTION OF DRAWINGS

FIG. 1 is a schematic structural diagram of an embodiment of a high-voltage rubber wire light according to the present invention.

Reference numerals in FIGURE: 1. power plug: 2. light-emitting diode (LED) light set; 3. light-emitting diode: 4. resistor; 5. bridge rectifier; 6. positive wire; 7. negative wire; and 8. insulating protective sheath.

### DETAILED DESCRIPTION OF THE EMBODIMENTS

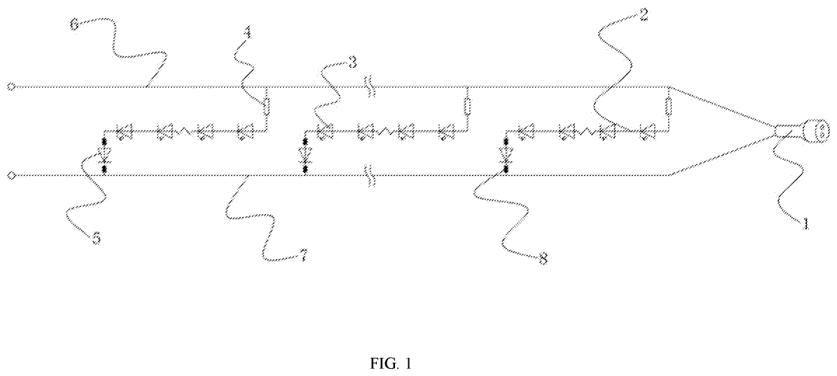

The embodiment of a high-voltage rubber wire light according to the present invention is further described with reference to FIG. 1.

For ease of explanation, the relative spatial terms such as “up”, “down”, “left”, and “right” are used in the embodiment to explain the relationship between one element or feature and another element or feature shown in the FIGURE. It should be understood that in addition to the orientations shown in the FIGURE, the spatial terms are intended to include different orientations of an apparatus in use or operation. For example, if the apparatus in the FIGURE is inverted, the element described as being located “below” other element or feature will be positioned “above” other element or feature. Therefore, the exemplary term “below” may include both an upper and a lower orientation. The apparatus may be positioned in other manner (rotated 90° or positioned in other orientation), and the relative spatial description used here may be explained accordingly.

Moreover, the relational terms such as “first” and “second” are only used for distinguishing one component with the same name from another one, and do not necessarily require or imply any such actual relationship or order between these components.

A high-voltage rubber wire light includes a power plug 1. Power wires are embedded in the power plug 1 and provided with parallel light-emitting diode (LED) light sets 2. Each of the LED light sets 2 includes a plurality of light-emitting diodes 3, a resistor 4, and a bridge rectifier 5. The power wires include a positive wire 6 and a negative wire 7. A voltage between the power wires is set to be 110 V. Rubber wire sheaths are arranged outside the power wires, which may prolong the service life of the power wires. Each of the rubber wire sheaths is provided with an opening configured to be connected to an electrical wire. The resistor 4 is connected to the positive wire 6 via an electrical wire, and the electrical wire is sheathed with a rubber wire sheath. The rubber wire sheath for sheathing the electrical wire is seamlessly connected to the rubber wire sheath for sheathing the positive wire 6. The bridge rectifier 5 is connected to the negative wire 7 via an electrical wire, and the electrical wire is sheathed with a rubber wire sheath. The rubber wire sheath for sheathing the electrical wire is seamlessly connected to the rubber wire sheath for sheathing the negative wire 7. Each of the LED light sets 2 has one end connected to the positive wire 6 and the other end connected to the negative wire 7. The light-emitting diodes 3, the resistor 4, the bridge rectifier 5, and the power wires are connected via electrical wires, and rubber wire sheaths are arranged outside the electrical wires. The resistor 4 is arranged at one end close to the positive wire 6. The bridge rectifier 5 is arranged at one end close to the negative wire 7. The light-emitting diodes 3 are arranged between the resistor 4 and the bridge rectifier 5. The electrical wire between the light-emitting diodes 3, the electrical wire between the light-emitting diodes 3 and the resistor 4, and the electrical wire between the light-emitting diodes 3 and the bridge rectifier 5 are sheathed with the rubber wire sheaths. Pins of the bridge rectifier 5 are connected to the light-emitting diodes 3 and the negative wire 7, respectively, and the joints are sheathed with insulating protective sheaths 8. The insulating protective sheaths 8 are seamlessly connected to rubber wire sheaths arranged at the joints, which may greatly protect the connection stability and insulation of the bridge rectifier 5. The LED light sets 2 are evenly and equidistantly arranged between the power wires. The length of the LED light sets 2 and the number of the light-emitting diodes 3 arranged on the LED light sets may be increased or decreased according to an actual situation, which is convenient to achieve the effect of decorative lighting in different regions. The present invention is simple and practical to connect and mount, has a simple and convenient production process, meets production requirements of a production line, may greatly improve production efficiency, and has the advantages of easiness in modeling and hanging compared to a rubber wire light with a circuit board on the market.

The above is only the preferred embodiment of the present invention, and is not intended to limit the present invention. Common changes and substitutions made by those skilled in the art within the scope of the technical solution of the present invention should be all included in the scope of protection of the present invention.

What is claimed is:

1. A high-voltage rubber wire light, comprising a power plug, wherein power wires are embedded in the power plug and provided with parallel light-emitting diode (LED) light sets, and each of the LED light sets comprises a plurality of light-emitting diodes connected in series, a resistor, and a bridge rectifier.

2. The high-voltage rubber wire light according to claim 1, wherein the power wires comprise a positive wire and a negative wire, and a voltage between the power wires is set to be 110 V.

3. The high-voltage rubber wire light according to claim 2, wherein each of the LED light sets has one end connected to the positive wire and the other end connected to the negative wire, the light-emitting diodes, the resistor, the bridge rectifier, and the power wires are connected via electrical wires, and rubber wire sheaths are arranged outside the electrical wires.

4. The high-voltage rubber wire light according to claim 1, wherein the resistor is arranged at one end close to the positive wire, the bridge rectifier is arranged at one end close to the negative wire, and the light-emitting diodes are arranged between the resistor and the bridge rectifier.

5. The high-voltage rubber wire light according to claim 4, wherein pins of the bridge rectifier are connected to the light-emitting diodes and the negative wire, respectively, and the joints are sheathed with insulating protective sheaths.

6. The high-voltage rubber wire light according to claim 1, wherein the LED light sets are evenly and equidistantly arranged between the power wires.
